(19) United States
(12) Patent Application Publication
(10) Pub. No.: US 2013/0129095 A1
(43) Pub. Date: May 23, 2013

(54) Key Delivery

(71) Applicants: James W. Fahrny, Parker, CO (US); Kyong Park, Woodbine, MD (US)

(72) Inventors: James W. Fahrny, Parker, CO (US); Kyong Park, Woodbine, MD (US)

(73) Assignee: COMCAST CABLE COMMUNICATIONS, LLC, Philadelphia, PA (US)

(21) Appl. No.: 13/300,264

(22) Filed: Nov. 18, 2011

(51) Int. Cl. H04L 9/08; G06F 12/14

(52) U.S. Cl. 380/279; 713/189

(57) ABSTRACT

A multi-hierarchical key system is provided such that users receive timely key renewals when required so that access to authorized content is not disrupted. Timely renewals of keys may occur continuously for various services while minimizing network traffic. The multi-hierarchical key system may be used in an adaptive streaming environment.

The features described herein relate generally to communication security in systems that control access. Some aspects relate to license and key based viewing systems.

### BACKGROUND

Classical digital rights management solutions involve providing licenses to millions of users to watch various authorized media content provided by service providers. Licenses are renewed on a periodic basis depending upon a service provider's system and numerous contract obligations with content providers. Licenses for viewing media content may include keys for decrypting streamed content by an authorized user device. The keys may be used to access the delivered media content stream.

Currently, new licenses and keys are periodically delivered or refreshed prior to expiration. However, network loading and the ability to securely and seamlessly incorporate new licenses and keys may be very difficult. For instance, depending upon the type of programming being delivered, licenses and keys may be required to be refreshed at different frequencies based on different levels of threat exposure. Moreover, keys may be required to be revocable and potentially renewable for content streams that have the most threat exposure.

In addition, with the advent of adaptive streaming of content (delivering content at variable bit rates) additional problems arise as current classical digital rights management systems are not scalable to provide an effective digital rights management solution. For instance, in an adaptive streaming environment, content may be delivered in a more fragmented pattern due to network traffic and changing bandwidth utilization rates to improve the user viewing experience. Fragmented delivery of content dramatically increases the number of required licenses and key rotations needed and current digital rights management systems are not scalable to an acceptable degree. For instance, current digital rights management systems may be acceptable for distributing video on demand (VOD) content but are not scalable for linear content delivery. Furthermore, current systems such as billing and subscriptions systems are not scalable to handle continuous (e.g., daily) addition and deletion of numerous users, which would increase with linear content delivery.

Therefore, the disclosure identifies and addresses a need for a scalable solution which allows renewability of keys seamlessly and continuously while efficiently supporting streaming of content.

### SUMMARY

An aspect of the disclosure provides for optimized key delivery in a streaming environment, such as a multicast environment. In an embodiment, the content may be delivered in an adaptive streaming environment. In another embodiment, a multi-hierarchical key system is provided such that users receive timely key renewals when required so that access to authorized content is not disrupted. Timely renewals of keys may occur continuously for various services while minimizing network traffic.

In another aspect of the disclosure, user services may be grouped and analyzed so that updated keys are delivered based on a scheduled grouping of services. The keys may be delivered for each grouping spaced in time relative to other groups to allow time for user device acceptance, decryption, authentication, validation, and insertion when synchronized with key changes. Users belonging to various groups may receive keys to only those services for which they are authorized based on a key rotation schedule. In an embodiment, keys such as subscription keys may be delivered within a license which may be used to unlock content keys.

Other details and features will also be described in the sections that follow. This summary is not intended to identify critical or essential features of the inventions claimed herein, but instead merely summarizes certain features and variations thereof.

### BRIEF DESCRIPTION

Some features herein are illustrated by way of example, and not by way of limitation, in the figures of the accompanying drawings and in which like reference numerals refer to similar elements.

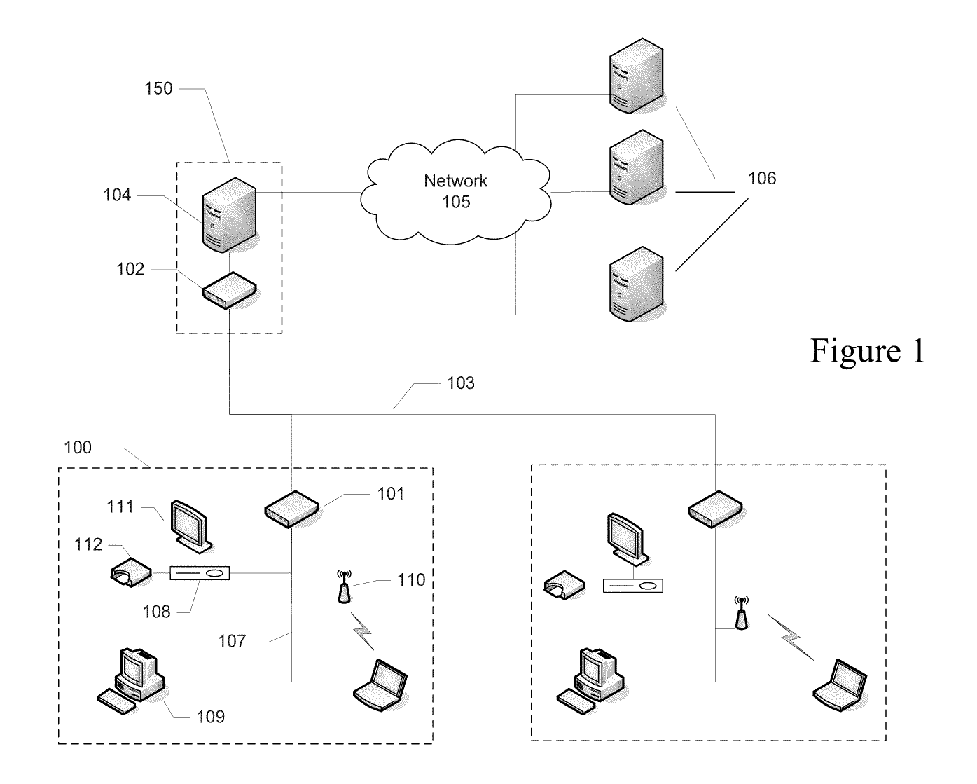

FIG. 1 illustrates an example content distribution network in accordance with an aspect of the disclosure.

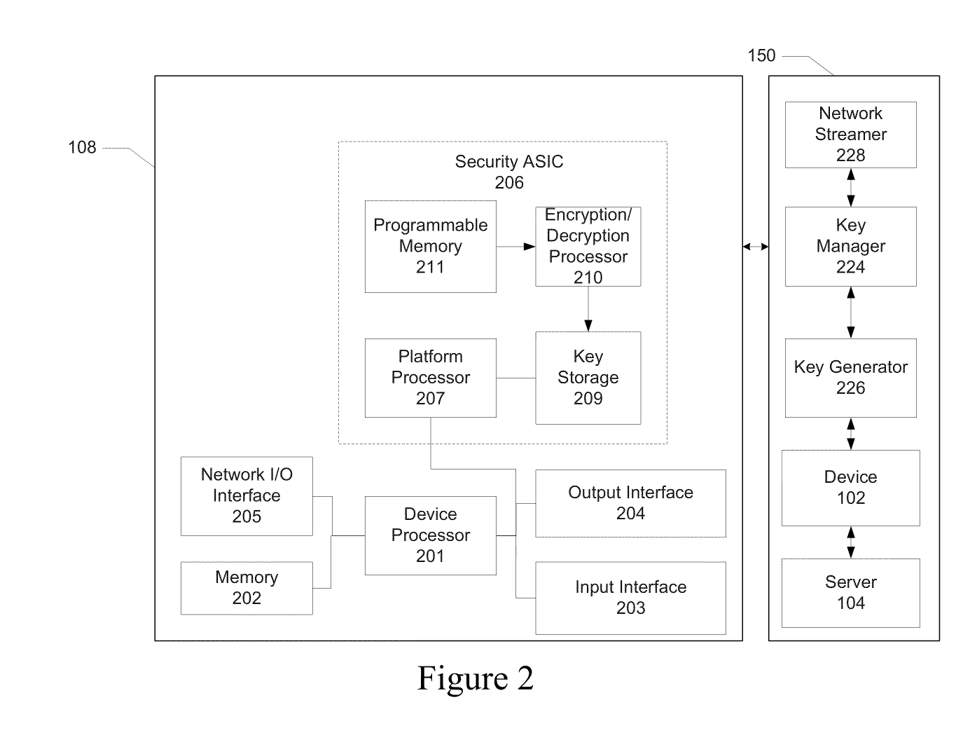

FIG. 2 illustrates an example content access device which may communicate with a service provider system in accordance with an aspect of the disclosure.

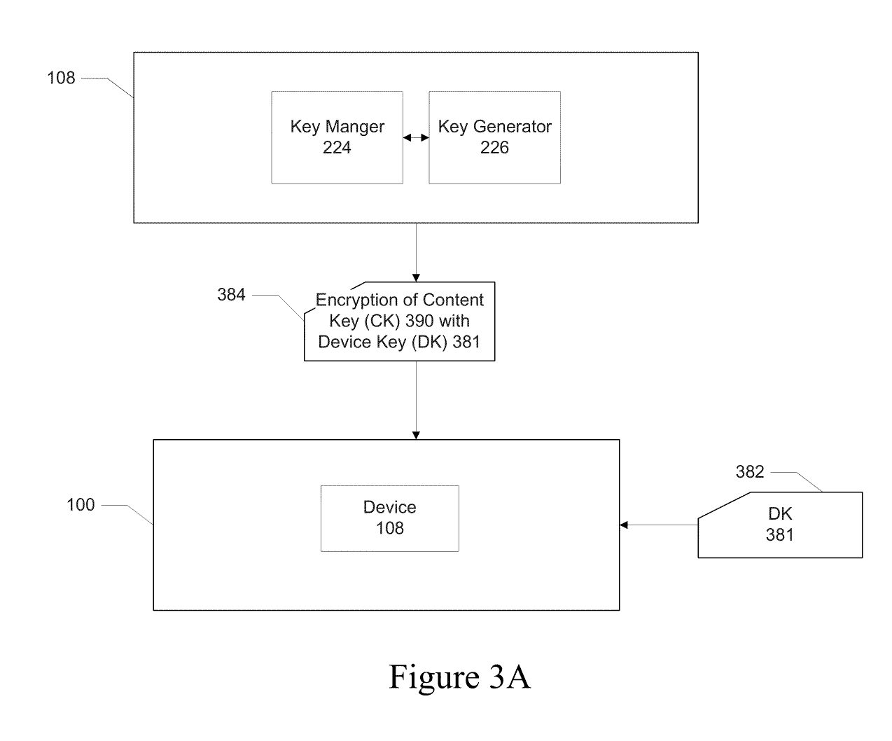

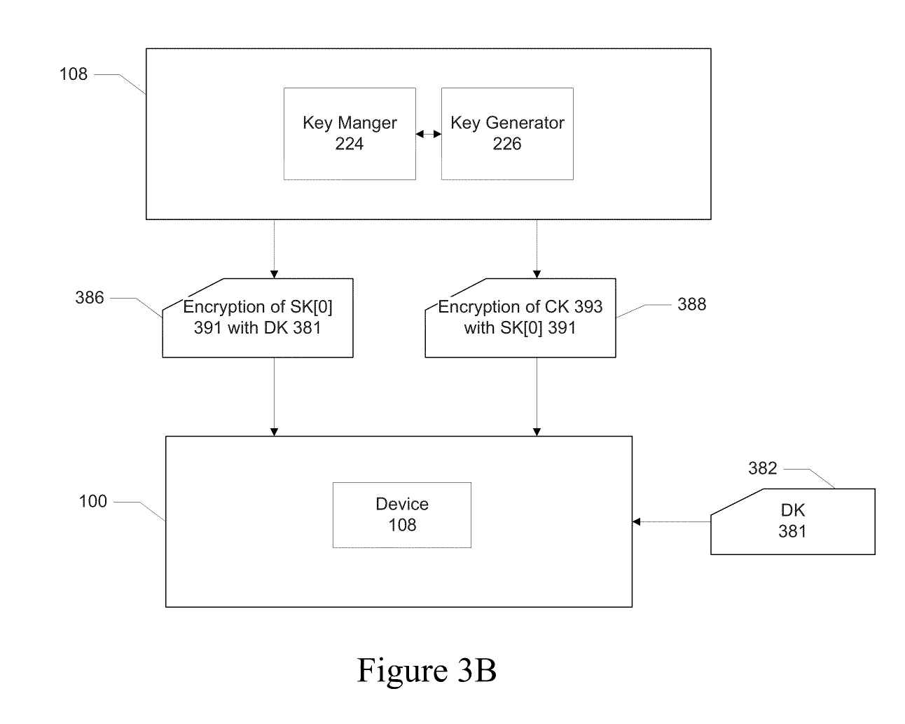

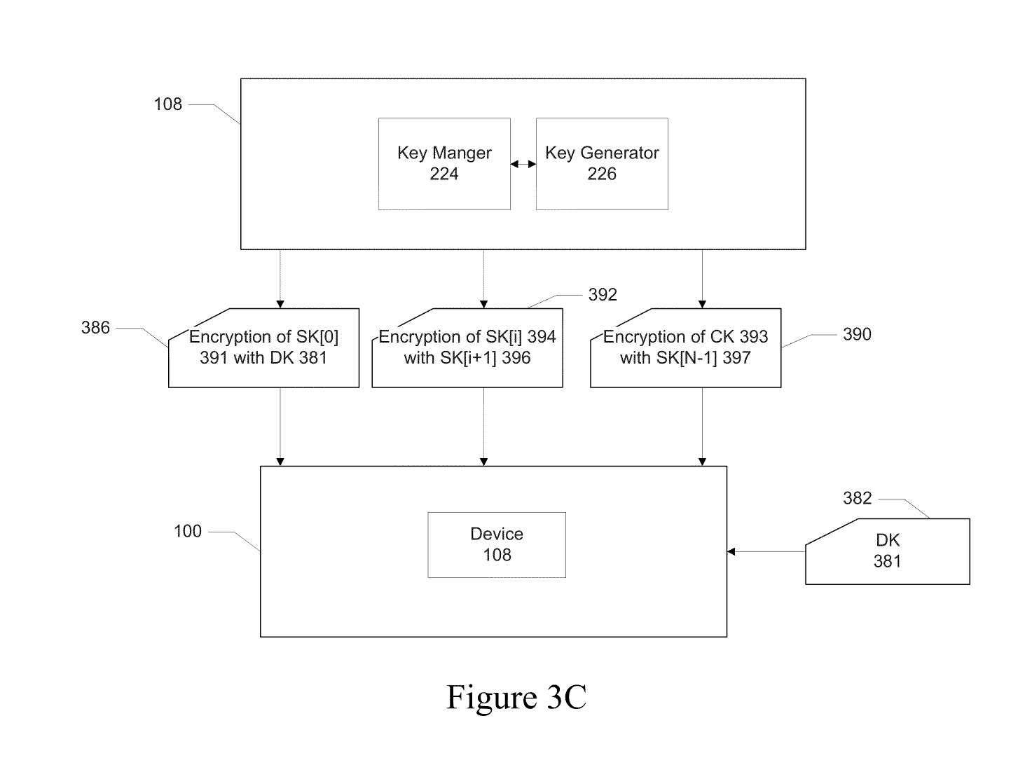

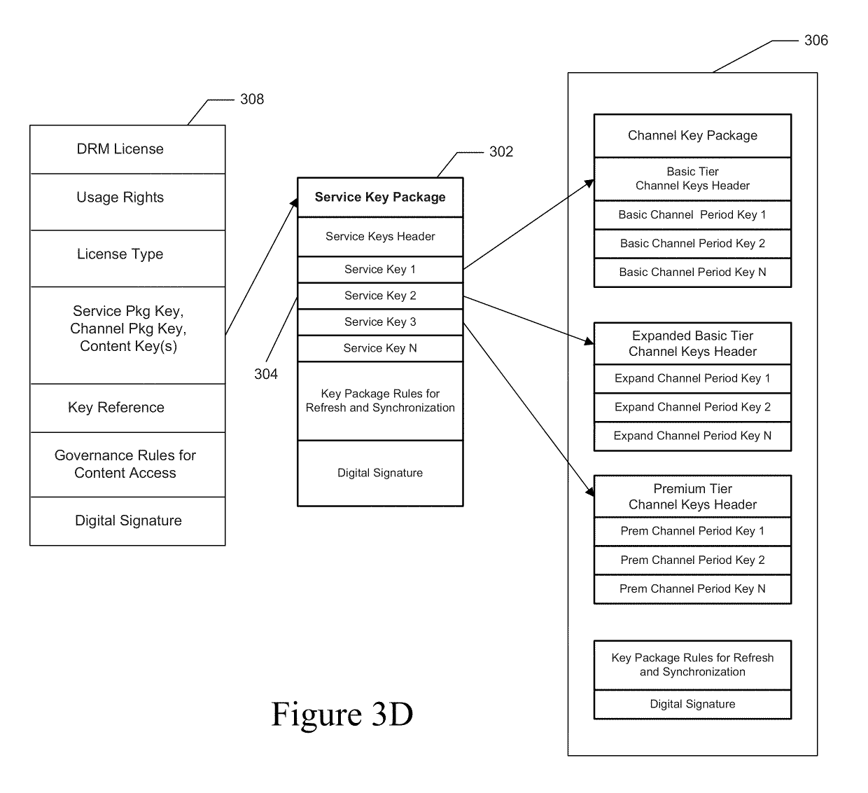

FIGS. 3A-3D illustrate expandable/contactable hierarchies for key management in accordance with at least some of the various aspects of the disclosure.

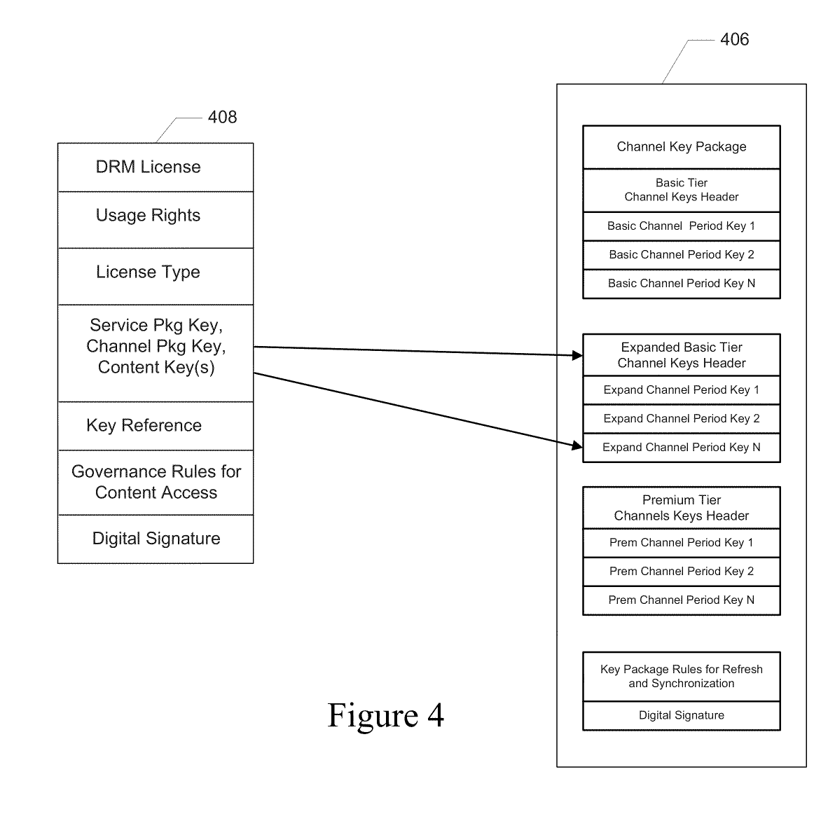

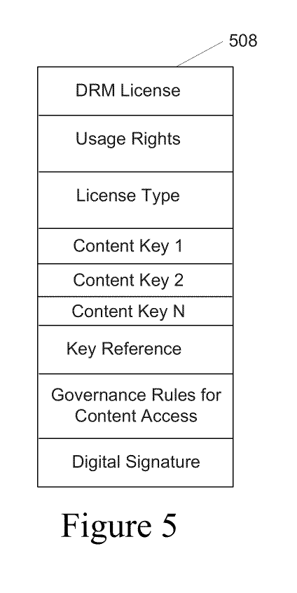

FIGS. 4 and 5 illustrate multi-tier hierarchies for key management in accordance with at least some of the various aspects of the disclosure.

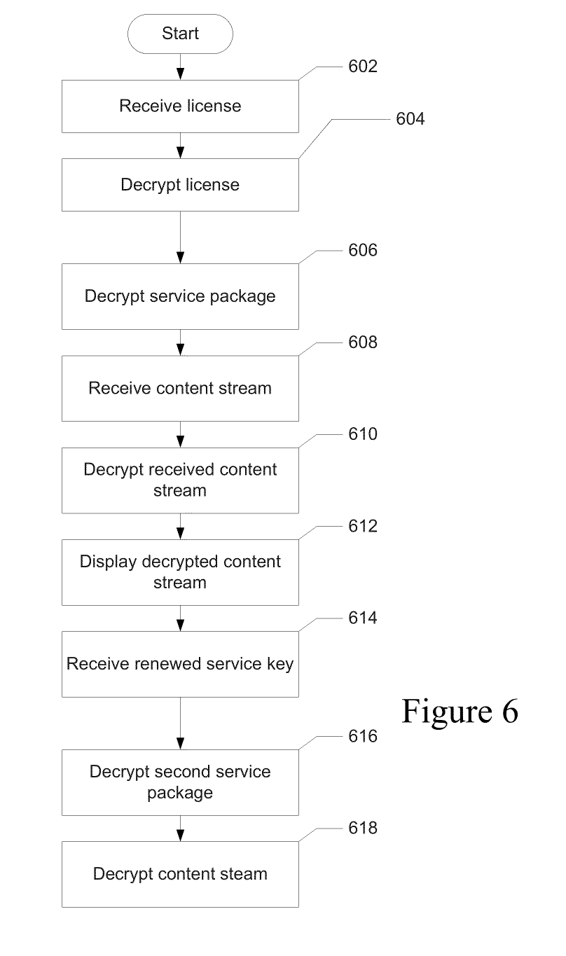

FIG. 6 illustrates a method for accessing an authorized content stream in accordance with an aspect of the disclosure.

### DETAILED DESCRIPTION

FIG. 1 illustrates an example content (e.g., data, media, information, services, etc.) distribution or access network that can be used to receive or access various types of information, such as video content (movies, pay-per-view, etc.), audio content, Internet data, etc., in accordance with an aspect of the disclosure. Starting with a user's home 100 or any other location such as a business or institution, the user may have a network interface device such as a gateway 101. Gateway 101 may be a device (such as a coaxial cable modem, optical fiber modem, etc.) that is configured to communicate with another corresponding device 102 via intermediate communication links 103. The nature of the devices 101/102 may depend on the type of communication links 103 being used. For example, links 103 may be coaxial cables, in which case the modems 101/102 may be a coaxial cable modem and a cable modem termination server, respectively. Other types of links may be used as well, such as optical lines, hybrid fiber/coaxial cable (HFC), satellite, cellular telephone, local Wifi wireless, WIMAX, etc. . . . , and different corresponding types of interface devices 101/102 may be used.

Device 102 may be located external to the home 100, such as at a service provider's processing facility 150 (e.g., a headend, a central office, etc.). Device 102 may communicate with one or more other servers 104, which may in turn be connected to an even larger communication network 105. Communication network 105 may be any desired type of network, such as a wide area network (WAN), cellular telephone, satellite network, Internet, Intranet, etc., and may offer connection to even more servers 106. The other servers 106 may, in turn, provide various types of services such as delivery of media content, and Internet purchasing.

In an embodiment, data corresponding to services may be transmitted and received from device 102 or a provider's processing facility 150. Service data may include broadcast data (e.g., television broadcast programming), narrowcast data (e.g., VOD and switched digital video (SDV) programming) and unicast data (e.g., high speed data (HSD) service providing Internet connectivity to users and VoIP or other type of telephone service). The backbone network may be, e.g., a service operator's national or local IP network, the Internet, and some combination of the Internet and a service operator's network.

Within home 100, gateway 101 may allow any device in the home to access device 102 and, in turn, any of the other servers 104/106 and network 105. To provide this connectivity, gateway 101 may be connected to one or more in-home communication networks 107 (e.g., in-home coaxial cable, MoCA (Multimedia Over Coax Alliance), Ethernet, power line network, etc.). Other devices, such as a media interface device 108 (e.g., set-top box, digital video recorder, mobile television, television, etc.), computer 109, or wireless access point 110 may also be connected to the in-home network, and may use the network to communicate with gateway 101. In some embodiments, a home may have multiple gateways, and in other embodiments, some or all of the gateways may be integrated into the various devices described herein. So, for example, media interface device 108 may include gateway 101, but to simplify the present discussion, FIG. 1 discusses media interface device 108 and gateway 101 separately. In addition, media interface device 108 may be a standalone device or part of another device such as a personal computer, smartphone, and/or a display etc.

The in-home devices may use gateway 101 for any variety of purposes, such as accessing the Internet or other network, accessing servers 106, etc. Some devices, such as media interface device 108, may use gateway 101 to receive media content that is then displayed on a display device such as a television, mobile device, or computer monitor 111.

To provide secure access to that content, the supplier of the content (e.g., a computing device such as a content server 106, or server 104), may through the service provide a signed license to the user to receive and access various media content. In addition, the service provider may also encrypt the content when delivering it to gateway 101 and media interface device 108. Media interface device 108 may need to decrypt the content before displaying it on the display device 111 (which may be integrated with the media interface device 108 in some embodiments).

This decryption may be performed, for example, by media interface device 108 using a hierarchy of keys one of which may be a device key that is stored within media device 108. Alternatively, the decryption may be performed by an external security module 112, such as a smart card, that is provided separately to the user. Having the separate smart card 112 may allow customers to purchase media devices 108 from a source other than the content provider, and to merely obtain a small card from the content provider.

FIG. 2 illustrates an example embodiment of media interface device 108. The interface device 108 may be in communication with device 102 or a provider's processing facility 150 in accordance with an aspect of the disclosure. Media interface device 108 may include one or more processors 201. The processor 201 may be general purpose or application specific, and may be configured to execute software instructions that are stored on a computer-readable memory 202 to cause media interface device 108 to perform any of the features described herein. The memory 202 may be any desired type of computer-readable medium, such as one or more hard drives, magnetic and/or optical disk drives, FLASH memory, etc.

The processor 201 may receive inputs and commands from a user via one or more user input interfaces 203. A wide variety of user input interfaces 203 may be used. For example, the user input interface 203 may include an infrared receiver circuit, configured to receive inputs from a handheld infrared remote control. The input interface 203 may include one or more pushbuttons physically located on a chassis of media interface device 108. Other user input interfaces may include keyboards, mice, touch pads, microphones, and trackballs.

The processor 201 may also provide outputs to the user via one or more output user interfaces 204. Any desired type of output user interface can be used. For example, the output interface 204 may include a video signal interface (e.g., HDMI—High Definition Multimedia Interface video, analog/component/composite video, VGA—Video Graphics Adapter, DVI—Digital Video Interface, etc.), audio signal interface (e.g., multiple audio channel output lines, piezoelectric buzzers, etc.), wireless output (may be combined with wireless user input interface 203 as well).

As noted above, the media interface device 108 may be used to receive content from an external source, such as a media content server. To facilitate communicating with that external source (which communications may pass through gateway 101), media interface device 108 may include one or more network input/output interfaces 205. The interface 205 may be of any desired type, such as an Ethernet, USB (Universal Serial Bus), coaxial, MoCA (Multimedia over Coaxial Alliance), etc. In some embodiments, gateway 101 may be incorporated as part of the media interface device 108, so the interface 205 may simply be a direct board-level connection, or internal wiring/cabling. The interface 205 need not be limited to communicating with gateway 101, and instead may also include circuitry and components for communicating with other networks as well, such as networks in the home, local Wi-Fi (e.g., IEEE 802.11)/WIMAX, etc.

As also noted above, the content received by media interface device 108 may be in an encrypted form, for security or other reasons. To handle decryption of that content, media interface device 108 may include a security module, such as a security application specific integrated circuit (ASIC) 206 or a trusted processor of a system on a chip (SOC). The Security ASIC 206 may include its own processing capability, such as a security platform processor 207, for coordinating and managing the decryption of the encrypted content. In some embodiments, the actual decryption is handled by circuitry on an external security processor, such as a removable smart card, and the platform processor 207 coordinates the encryption communications. The smart card may be any form factor, such as USB (Universal Serial Bus), PCMCIA (PC Card), etc.

The decryption (and/or encryption) may typically involve the use of one or more encryption/decryption keys. The keys, which are typically secret data values, may be stored in a secure memory or key storage 209. The key storage 209 may be any desired form of memory, similar to memory 202, but in some embodiments the memory contains additional security features to impede unauthorized access. For example, the contents of the storage itself may be further encrypted, such that only platform processor 207 is able to read it.

The ASIC 206 may also include an encryption/decryption processor 210, which may be a standalone processor circuit, or part of the software programming of the platform processor 207. The encryption/decryption processor 210 may also be trusted processor. The encryption/decryption processor 210 may be configured to perform a predefined encryption algorithm on data, such as triple-DES or AES, and supply the result to the key storage 209. The data provided may come from a separate chip used during manufacture, or a board level connection to an external data source, and may include a randomly generated seed value. Additionally, the data may include a unique key value that is individually assigned to the ASIC 206, and stored in a one-time programmable memory 211.

FIG. 2 also illustrates a key manager 224, key generator 226, and network streamer 228 which may be housed at processing facility 150 in accordance with an aspect of the disclosure. In an embodiment, key manager 224 may create a list of multicast groups based on service packages received by user devices. In an embodiment, multicast groups may also be determined based on various device types. The service packages may include types and forms of media content that a user has rights to access and utilize. In an embodiment, key manager 224 may list all devices and their related subscriptions receiving linear and VOD services for its network node through back office services.

In another aspect of the disclosure, key manager 224 may periodically make requests to read only entitlement service for devices to validate their current service subscriptions, which is used to generate the service key packages. The key packages may be transmitted to each user device based on a periodic timeout in the key manager server or based on a request from a user device

In an aspect of the disclosure, key manager 224 may manage device types with different levels of key hierarchies simultaneously. For instance, linear and VOD channel key packages delivered to a PC and MAC may be decrypted by one or more keys delivered in a license. In an embodiment, the keys delivered in the license may be client keys. However, gateway 101 may have an additional middle tier of keys whereby the license keys decrypt the service key package and the service key packages are used to decrypt the channel or content packages of keys.

In another aspect of the disclosure, key manager 224 may inform a license server that keys delivered in a license are used to directly encrypt the VOD content or the linear channel. In an embodiment, a license manager may signal key manager 224 not to prepare service key packages or channel key packages for certain devices or device types when keys are delivered in the license and when a reduced hierarchy is utilized.

In another aspect of the disclosure, key manager 224 may be able to deliver a series of keys (rotation package) to user devices for each video channel(s) or VOD asset. These keys may be synchronized with the content stream and the stream signals when the next key is loaded for seamless decryption of the video content.

In another aspect of the disclosure, channel key packages/content key packages and service key packages may be able to be immediately pushed to newly joined user devices if the next multicast message for the related services is more than a predetermined time. For instance, the time may be related to when a new device joins a service package. In an embodiment, the maximum time may be approximately sixty seconds plus latency.

In another aspect of the disclosure, key manager 224 may be able to acquire as many new keys as needed to deliver to the user devices sets of service key packages and channel key packages. In an embodiment, key generator 226 generates and supplies the requested keys. In an embodiment, key generator 226 may supply keys to key manager 224 in a secure manner and may have an encrypted cache of keys that the key generator 226 marks as new when added to a cache. In an embodiment, key manger 224 may mark key locations as used once any keys have been issued by key manager 224.

In an aspect of the disclosure, a media interface device 108 may request keys when key buffers are below a predetermined threshold level and a known key change is coming in the content stream. In an embodiment, channel key packages may be delivered prior to use in the content stream so that a user device has time to validate a package and prepare it for synchronization with the stream.

In another aspect of the disclosure, key manager 224 may validate user requests for signature validation and for entitlement rights on keys requested.

In yet another aspect of the disclosure, channel key packages and service key packages may be created in sub groups based on service subscriptions. The created key packages may be delivered to user devices signed and encrypted.

In another aspect of the disclosure, key manager 224 may be the device that removes revoked or non-payer devices from the multicast groups in a predetermined time frame. In an embodiment, key manager 224 may add devices to multicast groups within a predetermined time frame.

In another aspect of the disclosure, key manager 224 may securely deliver keys to a bulk encryptor directly to network streamer 226 such that these content keys are associated with the correct linear channel or the correct VOD asset.

In another aspect of the disclosure, key manager 224 may deliver program rotation packages of keys to network streamer 228 or bulk encryptor for a defined duration. In an embodiment, key manger 224 may deliver keys with crypto periods that are of a constant value between keys and crypto periods that vary.

In another aspect of the disclosure, key manger 224 may be capable of a secure static startup in various ways which may include: a) key ladder configuration for devices such as set-top device types, PCs, MAC, and portable device types, b) crypto periods for key rotations, c) offset times from crypto period expirations to guarantee pre-delivery in time, d) pre-delivery of licenses and both key package types, e) configuration of service key packages and channel key packages, and f) configuration of multicast groups by service packages (Linear and VOD). In addition, key manager 224 may also be capable of a secure dynamic configuration during runtime in various ways which may include: a) key ladder configuration for set-top device types, PCs, MAC, and portable device types, b) crypto periods for key rotations, c) offset times from crypto period expirations to guarantee pre-delivery in time, d) methods for building key packages from entitlements for user, and e) methods and delivery response time for pushing key packages to newly subscribed devices.

In yet another aspect of the disclosure, key manager 224 may determine if new devices that join domains are eligible for delivery of keysets by requesting information from a domain management service. In an embodiment, key manger 224 may determine if the user and user device are a valid combination by requesting this validity from the domain manager service when a new device is to be added to the key delivery list.

In an aspect of the disclosure, keys delivered in the license may be used to unlock additional keys that may or may not be delivered in the content stream. The keys delivered in the license may be signed with media data or a security policy. In an embodiment, the keys delivered in the license may be used to unlock an additional hierarchy of keys that may or may not be delivered in the content stream. In addition, keys may be delivered in parallel with the delivery of the media content. This may ensure that content, when delivered, may be readily accessed by authorized users.

In another aspect of the disclosure, a key generation and delivery system for use in handling different digital rights management solutions is disclosed and implemented in various embodiments of the disclosure. In an embodiment, a key generation and delivery structure may include a group of keys forming a key hierarchy.

FIGS. 3A-3D illustrate examples of expandable/contactable hierarchies for key management in accordance with some aspects of the disclosure. In an embodiment, a key hierarchy may include a single key or a group of keys. A single key hierarchical structure may also be called a flat key structure.

FIG. 3A illustrates a flat hierarchal key structure in accordance with various aspects of the disclosure. In FIG. 3A, key manager 224 may encrypt a content key (CK) 390 using a device key (DK) 381. The content key 390 may be transmitted in content stream 384 or other data stream transmission from key manger 224 to media interface device 108. Media interface device 108 may receive device key 381 in an alternative data transmission 382 and may be used to decrypt the received content key 390 in content stream 384. The decrypted content key 390 may then be used to decrypt a received content stream so that received content may be utilized by the user.

In yet another aspect of the disclosure, a multi-tier key hierarchy may be used to implement various embodiments. For instance, in an embodiment, a multi-tier hierarchy may include device keys, content keys, and service keys. In aspect of the disclosure, device keys may be unique to each media device such as media interface device 108.

In another aspect of the disclosure, service keys may be wrapping keys. In an embodiment, each service key may wrap one or more subsequent service keys. For example, one service key SK[i] may encrypt many instances of SK[i+1]. In another embodiment, only a single service key may be used in a multi-tier key hierarchy.

FIG. 3B illustrates an embodiment of a multi-tier hierarchy key in accordance with various aspects of the disclosure. In FIG. 3B, key manager 224 may encrypt a content key (CK) 393 using a service key such as service key SK[0] 391. The encrypted content key 393 may be delivered to media interface device 108 in content stream 388. In addition, service key SK[0] 391 may be encrypted by key manger 224 using device key (DK) 381. The encrypted service key SK[0] 391 may be delivered to media interface device 108 in a separate content stream 386. Upon receipt of content streams 386 and 388, media interface device 108 may decrypt service key SK[0] 391 using device key 381 and content key 393 using service key SK[0] 391. The decrypted content key 393 may then be used to decrypt a received content stream so that content may be utilized by the user.

In yet another aspect of the disclosure, multiple service keys may be implemented in a multi-hierarchical key structure in accordance with various embodiments of the disclosure. In a multiple service key embodiment, the first service key SK[0] may be encrypted using a device key. Each additional service key (SK) may be encrypted using a subsequent service key in the series (SK[i] using SK[i+1]). The last service key SK[N−1] may be used to encrypt the content key. FIG. 3C illustrates a multi-tier key hierarchy in accordance with an aspect of the discourse. In FIG. 3C, key manager 224 may encrypt a content key (CK) 393 using a service key such as service key SK[N−1] 397. As discussed above, SK[N−1] 397 may represent the last service key in the hierarchy. In addition, service key SK[i] 394 may be encrypted by key manger 224 using a service key (SK) such as service key (SK[i+1]) 396. Furthermore, SK[0], the first service key, may be encrypted using device key 381.

The encrypted service key SK[0] 391 may be delivered to media interface device 108 in a separate content stream 386. Furthermore, encrypted service keys SK[i] may be delivered to media interface device 108 in one content stream 392 or in multiple different content streams. Finally, content key 393 may be delivered to media interface device 108 in content stream 390. Upon receipt of content streams 386, 392, and 390 media interface device 108 may decrypt service key SK[0] 391 using device key 381 and content key 393 using the chain of decrypted service keys SK[N]. The decrypted content key 393 may then be used to decrypt a received content stream so that content may be utilized by the user.

In an aspect of the disclosure, a device key may be delivered in the license along with the media stream. The device key may be extracted from the license and used to decrypt the remaining hierarchy of keys such as service keys and content keys.

In another aspect of the disclosure, the hierarchy may be expanded and/or collapsed based on the type of services provided to users from a service provider. In an embodiment, the hierarchy may be selectable. For instance, a three tier may be used for content key management purposes in provider systems that deliver different services such as HD, linear, and VOD services. In an embodiment, a received license may include signaling that represents the selected key hierarchy.

In FIG. 3D, a service key package 302 is illustrated which includes service keys 304 for accessing content or channels keys 306. In an embodiment, license 308 may be decrypted using a device key which may be unique to the user device being used for accessing encrypted content. The expanded hierarchy in FIG. 3D may be used for content key management for services which include HD linear and VOD.

FIG. 4 illustrates an example of a contracted multi-tier hierarchy which may be used for services that include, for example, SD linear and VOD. In FIG. 4, license 408 may be decrypted using a device key which may be unique to the user device being used for access to an encrypted content stream. The device key may be used to decrypt channels keys 406 found in license 408. Further in FIG. 4, use of a service package may not be necessary which may result in decreased network traffic. FIG. 5 illustrates a further contracted multi-tier hierarchy 508 which may be used for VOD services and other services.

As shown in FIG. 2, ASIC 206 may include a unique device key. The device key may be any desired type of data (e.g., a binary sequence, alphanumeric sequence, etc.), and may be permanently associated with the security ASIC 206. The user device manufacturer may store information in an association database correlating the device key with information identifying the security ASIC 206 (e.g., a unique serial number, media access control (MAC) address, etc.). This may occur, for example, during wafer fabrication, chip packaging, or any other desired time prior to delivery of the ASIC 206 (or product containing the ASIC 206). In some embodiments, the security installation and key derivation steps may be performed by the same service provider who will be providing service to the media interface device 108, and not necessarily by the same entity who physically manufactured the ASIC 206 or media interface device 108.

In an embodiment, a device manufacturer (or service provider) may install security processing and/or functionality onto the ASIC 206, such as through installation of computer-executable instructions on a computer-readable medium coupled to the platform processor 207, or the addition of encryption circuitry.

FIG. 6 illustrates a method for accessing an authorized content stream in accordance with an aspect of the disclosure. In FIG. 6, a license may be received in step 602. The license in step 604 may be decrypted by a device key unique to the decrypting hardware. In an embodiment, the license may include at least one service key which may be used to decrypt a service package. In another embodiment, the license may include a hierarchy of keys for use in decrypting a content stream. In step 606, the service package may be decrypted using the service key. The service package may include at least one content key. In step 608, a content stream may be received by a user device. The content stream may be delivered in an adaptive streaming environment so that bandwidth may be efficiently utilized. The received content stream, which may be fragmented, may be decrypted with the at least one content key in step 610. Access to the content stream may be provided to the user in step 612.

In an additional embodiment, a renewed service key may be received in step 614. The renewed service key may be decrypted by a second service package received by the user device. The renewed service key may be used to decrypt the second service package in order to obtain content keys as shown in step 616. The new content keys may be used to decrypt a received content stream as shown in step 618.

Although example embodiments are described above, the various features and steps may be combined, divided, omitted, and/or augmented in any desired manner, depending on the specific secure process desired. This patent should not be limited to the example embodiments described, but rather should have its scope determined by the claims that follow:

We claim:

1. A device comprising:
a memory storage area storing a license having a signature, the license including at least one key;
a processor in communication with the memory storage and configured to perform the following:
decrypting the license using a device key;
verifying the signature in the decrypted license;
storing the at least one key in the memory storage area;
receiving a content stream; and
decrypting the received content stream using the at least one key stored in the memory storage area.

2. The device of claim 1, wherein the at least one key comprises a group of keys, the group of keys forming a hierarchy of keys.

3. The device of claim 2, wherein the group of keys includes at least two service keys.

4. The device of claim 3, wherein a last service key, of the at least two service keys, encrypts a content key.

5. The device of claim 4, wherein the first service key is encrypted by the device key.

6. The device of claim 2, wherein the group of keys includes at least one service key and at least one content key.

7. The device of claim 1, further comprising receiving an updated license, the updated license including at least one new key.

8. The device of claim 7, wherein the at least one new key comprises a group of new keys, the group of new keys forming a revised hierarchy of keys.

9. The device of claim 1, wherein the device key is unique to the device.

10. The device of claim 1, wherein the processor comprises a trusted processor of a system on a chip.

11. The device of claim 1, wherein the processor comprises a secure microprocessor.

12. The device of claim 1, wherein the received content stream comprises a fragmented content stream.

13. A method, comprising:
receiving a license in a streaming environment, the license including at least one service key;
decrypting, by a processor, the license using a device key;
using the at least one service key to decrypt a service package, by the processor, the service package including at least one content key;
receiving a content stream; and
decrypting, by the processor, the received content stream using the at least one content key.

14. The method of claim 13, wherein the content stream comprises a fragmented content stream.

15. The method of claim 13, wherein the streaming environment comprises an adaptive streaming environment.

16. The method of claim 13, further comprising:
receiving a renewed service key;
decrypting, by the processor, a second service package using the renewed service key, the second service package including new content keys; and
decrypting, by the processor, a received content stream using the new content keys.

17. The method of claim 16, wherein the renewed service key is received based on a predetermined schedule.

18. A method, comprising:
determining multicast groups based on service offerings;
encrypting a license using a device key, the license including a hierarchy of keys, wherein the hierarchy of keys includes at least a service key and a content key;
transmitting the license in a content stream; and
transmitting a renewed service key based on the determined multicast groups.

19. The method of claim 18, wherein the renewed service key is transmitted based on a predetermined schedule.

20. The method of claim 18 wherein the predetermined schedule is based on a multicast group.
